(19) United States
(12) Patent Application Publication
(10) Pub. No.: US 2004/0004539 A1
(43) Pub. Date: Jan. 8, 2004

(54) Vehicle legal compliance system

(76) Inventor: John W. Collins, San Clemente, CA (US)

Correspondence Address: LAW OFFICES OF ERIC KARICH, 2807 ST. MARK DR., MANSFIELD, TX, 76063, US

(21) Appl. No.: 10/601,962

(22) Filed: Jun. 23, 2003

Related U.S. Application Data
(60) Provisional application No. 60/391,126, filed on Jun. 24, 2002.

(51) Int. Cl. B60Q 1/00

(52) U.S. Cl. 340/425.5; 340/539.1

(57) ABSTRACT

A vehicle legal compliance system for reporting a compliance status of a vehicle has a central computer with a vehicle database, and a legal compliance indicator for indicating the legal compliance status of the vehicle. The vehicle database is adapted for storing a unique vehicle identifier associated with the vehicle, and the compliance status of the vehicle. The vehicle legal compliance system also has a central processor for converting the unique vehicle identifier and the compliance status into a status indicator signal. The status indicator signal is received by the legal compliance indicator, and a microprocessor decodes the status indicator signal for operably controlling the status indicator. The legal compliance indicator is adapted to be operably attached to the vehicle for displaying the status indicator and the results of the status indicator signal.

### CROSS-REFERENCE TO RELATED APPLICATIONS

This application for a utility patent claims the benefit of U.S. Provisional Application No. 60/391,126, filed Jun. 24, 2002, incorporated herein by reference.

### STATEMENT REGARDING FEDERALLY SPONSORED RESEARCH

Not Applicable

### BACKGROUND OF THE INVENTION

1. Field of the Invention

This invention relates generally to vehicle compliance indicating devices, and more particularly to a vehicle legal compliance system that indicates the legal compliance status of a vehicle.

2. Description of Related Art

Local, state, and national governments attempt to license, track, and otherwise monitor and control millions of vehicles, including automobiles and trucks. The vehicles are monitored and controlled for purposes of revenue collection (vehicle registrations) and citation enforcement, for public safety reasons (regular vehicle inspections, use of vehicles in serious crimes and monitoring stolen vehicles), and for other policy reasons, such as maintaining a minimum level of insurance on the vehicle.

Several systems have been developed for the purposes of tracking vehicles. Adcox et al., U.S. Pat. No. 6,359,570 B1, teaches a vehicle status device and system for remotely updating and locally indicating the status of a vehicle. The vehicle status device is located in a vehicle and indicates status information for the vehicle on a vehicle-status indicator on the vehicle when the device is interrogated by an interrogating unit. The device includes a database of status information for the vehicle and owner. An update receiver in the device receives encoded updated information from a wide area paging network for storage in the database. An interrogation receiver receives an interrogation signal from the interrogating unit, and a processor decodes the status information and sends it to the status indicator in response. The system also includes an interrogating unit which includes a police radar transmitter or a laser transmitter for transmitting the interrogation signal to the vehicle status device. The status indicator includes a set of summary status lights and may also include an LCD display for detailed status information. In an alternative embodiment, the device uses a wireless Internet access device to access external databases and download the vehicle status information either periodically or on demand. The information may be passed directly to the status indicator without the need for an internal database.

Hudson, U.S. Pat. No. 6,448,889 B1, teaches an apparatus attachable to a vehicle that can transmit the position of a vehicle to a telecommunications satellite or a telecommunications ground base station, and is particularly concerned with enabling authorities to police the vehicle with respect to its identity, location, theft and condition, as well as unlawful tampering of the apparatus. The apparatus may be in the configuration of a license plate.

Warner, U.S. Pat. No. 5,963,129, teaches a vehicle identification and information system for obtaining information on a plurality of vehicles. The system includes an identification unit, a remote unit, and a central microprocessor. The identification unit is installed in each vehicle and includes a first receiver for receiving information signals containing information regarding the vehicle from the central computer, a display device positioned on said vehicle for displaying information regarding the vehicle contained within the received information signal and an emergency signaling device for transmitting a distress signal to the receiver for display on the display device. The remote unit is positioned in a monitoring station and includes a transmitter for transmitting an information request signal to the central computer, a receiver for receiving an information response signal from the central computer, a microprocessor for processing the information response signal and a device for displaying the information received from the central computer. The central computer includes a database for storing the information regarding the plurality of vehicles and generates an information signal for transmission to both the identification unit and the remote unit.

The above-described references are hereby incorporated by reference in full.

The prior art teaches various vehicle identification and status indicating devices. However, the prior art does not teach a status indication system that includes the benefits of the present system. The present invention fulfills these needs and provides further related advantages as described in the following summary.

### SUMMARY OF THE INVENTION

The present invention teaches certain benefits in construction and use which give rise to the objectives described below.

The present invention provides a vehicle legal compliance system for reporting a compliance status of a vehicle. The vehicle legal compliance system has a central computer with a vehicle database, and a legal compliance indicator for indicating the legal compliance status of the vehicle. The vehicle database is adapted for storing a unique vehicle identifier associated with the vehicle, and the compliance status of the vehicle. The vehicle legal compliance system also has a central processor for converting the unique vehicle identifier and the compliance status into a status indicator signal. The status indicator signal is received by the legal compliance indicator, and a microprocessor decodes the status indicator signal for operably controlling the status indicator. The legal compliance indicator is adapted to be operably attached to the vehicle for displaying the status indicator and the results of the status indicator signal.

A primary objective of the present invention is to provide a vehicle legal compliance system having advantages not taught by the prior art.

Another objective is to provide a vehicle legal compliance system in which a compliance status of a vehicle is stored on a central computer, and a status indicator signal is used to operably control a legal compliance indicator installed on or in the vehicle to visually display the compliance status of the vehicle.

Another objective is to provide a vehicle legal compliance system that includes a status indicator for visibly displaying the compliance status of the vehicle.

Another objective is to provide computer system that includes external computers, such as a DMV computer, an insurance company computer, and a law enforcement computer, that are operatively integrated with the central computer via a computer network so that data in the external computers is automatically shared with the central computer and used to update the state of the legal compliance indicator.

Another objective is to provide a vehicle legal compliance system that reduces the costs of monitoring legal compliance of vehicles, and make it more difficult to commit fraud to avoid legal compliance.

A further objective is to provide a vehicle legal compliance system that enables the police or other person or system to quickly and easily identify and locate vehicles that are non-compliant, or that have been stolen, used to commit a crime, or are otherwise necessary to locate.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a block diagram of one embodiment of the present invention, a vehicle legal compliance system that utilizes a central computer to operably connect external computers for updating an legal compliance indicator that can be used to monitor one of a plurality of vehicles;

FIG. 2A is a front elevational view of the legal compliance indicator of a vehicle that is legally compliant, showing first and second red/green LEDs both illuminated green.

FIG. 2B is a front elevational view of the legal compliance indicator of a vehicle that has a registration that is due to expire in 30 days; showing the first red/green LED illuminated green and the second red/green LED illuminated red;

FIG. 2C is a front elevational view of the legal compliance indicator of a vehicle that has a registration that has expired, showing the first and second red/green LEDs illuminated red;

FIG. 2D is a front elevational view of the legal compliance indicator of a vehicle that has a registration that is over 60 days past due, that has been reported stolen, was involved in an accident or kidnapping, has outstanding citations, or some other serious outstanding danger, infraction, or other problem, showing the first and second red/green LEDs flashing red;

FIG. 3A is a front elevational view of a first embodiment of the legal compliance indicator, a license plate frame that includes a red LED and a green LED for, together, indicating the status of the vehicle being monitored;

FIG. 3B is a front elevational view of a second embodiment of the legal compliance indicator, an LED cluster that includes a pair of red LEDs and a pair of green LEDs mounted adjacent a resistor;

FIG. 4 is a rear elevational view of a vehicle that includes a third embodiment of the legal compliance indicator that is mounted adjacent a third brake light of the vehicle;

FIG. 5 is a block diagram illustrating a law enforcement vehicle responding to a red legal compliance indicator and retrieving information about the vehicle from the vehicle database of the central computer; and

FIG. 6 is a flow diagram of the function of one embodiment of the vehicle legal compliance system.

### DETAILED DESCRIPTION OF THE INVENTION

The above-described drawing figures illustrate the invention, a vehicle legal compliance system 10 for monitoring a plurality of vehicles 12. For simplicity, in this discussion we will often refer to a single vehicle 12 rather than the plurality of vehicles 12, with the understanding that the system is likely to be used to monitor many vehicles in the same manner in which it monitors the single vehicle 12. The vehicle legal compliance system 10 can alert the owner of the vehicle 12, police officers, or other parties that the vehicle 12 has not been registered, has been reported stolen, has been used in a kidnapping or other crime, or is being driven by a driver who does not carry insurance or has outstanding citations. The many uses and benefits of the present system 10 are described in greater detail below.

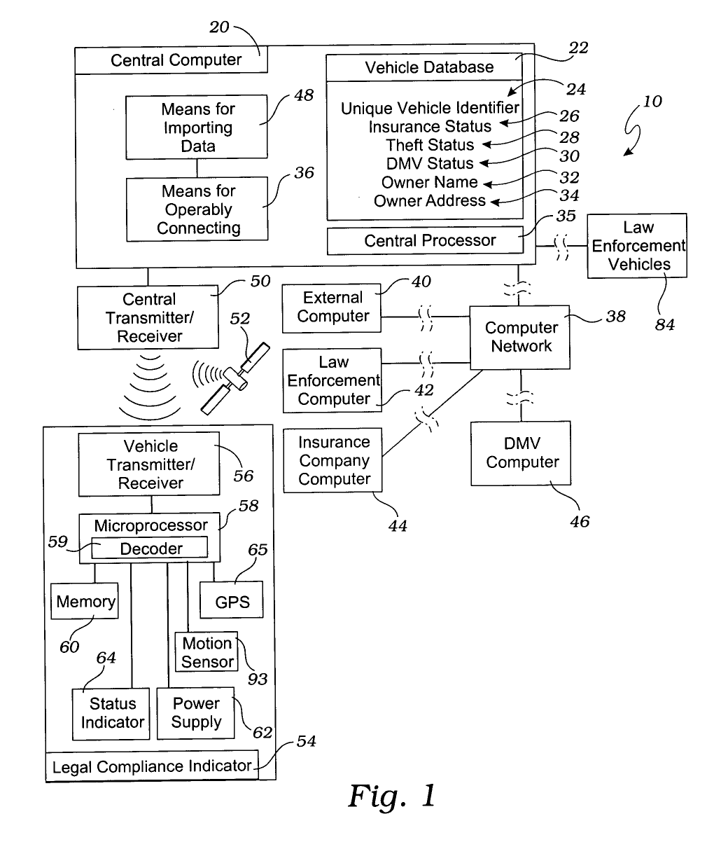

As shown in FIG. 1, the vehicle legal compliance system 10 utilizes a central computer 20 to operably connect external computers 40 for updating an legal compliance indicator 54 that can be used to monitor one of a plurality of vehicles 12. The central computer 20 includes a vehicle database 22 that stores data associated with the vehicle 12, including a unique vehicle identifier 24 such as the VIN number of the vehicle or other unique identifier. The vehicle database 22 may also store an insurance status 26 of the vehicle 12, a theft status 28 of the vehicle 12, a DMV status 30 of the vehicle 12. Each status could be listed as either compliant or non-compliant. In the alternative, more detailed information could also be included. For example, a registration deadline could be included in the DMV status 30 so that a warning can be given the driver before the registration expires, as described below. The vehicle database 22 may also include additional useful information, such as an owner name 32, an owner address 34, and any other information that would be useful to track.

The central computer 20 includes a means for operably connecting 36 to a computer network 38 such as the Internet or other network. In one embodiment, the means for operably connecting 36 is a modem connected to a high speed Internet connection such as a T1 connection. Such an Internet connection is well known in the art and is therefore not described in greater detail herein. Alternative and equivalent connections that can be devised by those skilled in the art should be considered within the scope of the invention. Alternatives include a direct connection via telephone, wireless, satellite, or other means using proprietary software installed on the various computers. The central computer 20 may be permanently connected to the computer network 38, or it may be limited to temporary connections established periodically for the update of information on the central computer 20.

Via the means for operatively connecting, the central computer 20 is connected to a plurality of external computers 40 such as a law enforcement computer 42, an insurance company computer 44, a DMV computer 46, and/or other similar databases of useful information about the vehicle 12 and/or the driver. The central computer 20 includes a means for importing data 48 from the plurality of external computers 40 into the vehicle database 22 of the central computer 20. The means for importing data 48 is preferably a computer software program that cooperates with software installed on each of the plurality of external computers 40 to periodically establish a link between the computers 20 and 40 and transmit the necessary data via the computer network 38. Since such software in known in the art, and can be implemented given the teachings of this invention, the software is not described in greater detail herein.

The central computer 20 is operable attached to a central transmitter/receiver 50 for establishing a wireless connection with any one of the plurality of legal compliance indicators 54 utilized by the vehicle legal compliance system 10. The wireless connection may be established through a satellite 52 to enable national or even global coverage of the vehicle legal compliance system 10. In alternative embodiments, the wireless connection could be made through a wireless network such as cellular, Blue Tooth, RF, or other system known in the art or developed in the future.

While the vehicle legal compliance system 10 is anticipated to function with a plurality of legal compliance indicators 54, potentially within the hundreds of millions of units, this application will discuss the function of a single legal compliance indicator 54 for purposes of clarity.

The legal compliance indicator 54 includes a vehicle transmitter/receiver 56 for receiving the communications from the central computer 20. The vehicle transmitter/receiver 56 is operably attached to a microprocessor 58, which is operably attached to a memory 60, a power supply 62, a status indicator 64, and any additional electronic components that those skilled in the art would consider helpful in carrying out the function of the invention as described. The legal compliance indicator 54 may be powered by the vehicle 12. In alternative embodiments, the legal compliance indicator 54 could be powered by a battery and/or solar cells operably connected to the legal compliance indicator 54.

The memory 60 stores the unique vehicle identifier 24 that has been assigned to the vehicle 12 on which the legal compliance indicator 54 has been installed. The microprocessor 58 functions to recognize transmissions that are directed to the unique vehicle identifier 24 that is stored in the memory 60, and to control the status of the status indicator 64 as directed by the central computer 20.

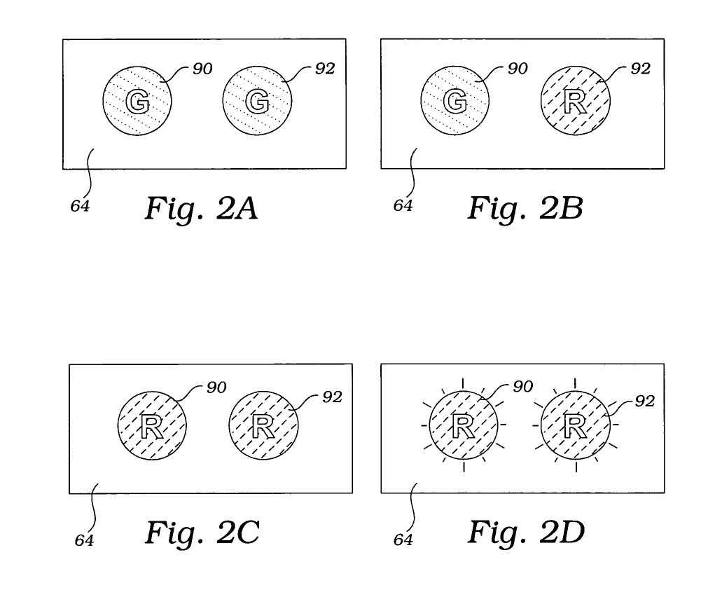

In one embodiment, as shown in FIGS. 2A-2D, the status indicator 64 includes first and second red/green LEDs 90 and 92. When the vehicle 12 is legally compliant, as shown in FIG. 2A, the first and second red/green LEDs 90 and 92 are both green. If the vehicle registration is due to expire in 30 days, the second red/green LED 92 may turn red, as shown in FIG. 2B, thereby providing a warning to the driver without triggering a police response. As shown in FIG. 2C, if the vehicle's registration has expired, the first red/green LED 90 also turns red thereby alerting the police that the vehicle 12 is non-compliant. The police who see a non-compliant vehicle 12 can immediately spot the two red lights and pull the vehicle 12 over for a citation. The number of LEDs used, the colors of these LEDs, and the circumstances that lead to the various states of illumination of the LEDs can be varied by those skilled in the art, and alternative combinations of LEDs and LED lighting patterns should be considered within the scope of the invention as claimed below.

As shown in FIG. 2D, in the event that the vehicle 12 is involved in a serious infraction, or in any way poses a safety risk to the public, both the first and second red/green LEDs 90 and 92 turn red and flash. Examples of what would trigger such a response could include a report that the vehicle was stolen, if the vehicle was involved in an accident or kidnapping, and possibly also if the vehicle has outstanding citations or some other serious outstanding danger, infraction, or other problem.

In one embodiment, the first and second red/green LEDs 90 and 92 are illuminated at all times that the vehicle 12 is in use. In this embodiment, it is preferred that the legal compliance indicator 54 include a motion sensor 93 (shown in FIG. 1) so that the first and second red/green LEDs 90 and 92 are only illuminated while the vehicle 12 is in use, and not when it is parked or otherwise inoperative. Those skilled in the art will recognize that the motion sensor 93 could alternatively include another equivalent sensor for sensing when the vehicle 12 is in use, such as when the ignition is turned on, and such alternative sensors should be included within the definition of the term motion sensor 93.

In an alternative embodiment, the first and second red/green LEDs 90 and 92 are not always illuminated, but are only illuminated when the legal compliance indicator 54 is interrogated using a remote trigger 55. The remote trigger may be a radar gun typically carried by the law enforcement vehicle 84. In alternative embodiments, the remote trigger 55 may be a specialized electronic interrogator that uses a wave trigger such as RF, laser, or some other wireless trigger to activate the legal compliance indicator 54. The structure and function of such a system can be devised by those skilled in the art, and is therefore not described in greater detail herein.

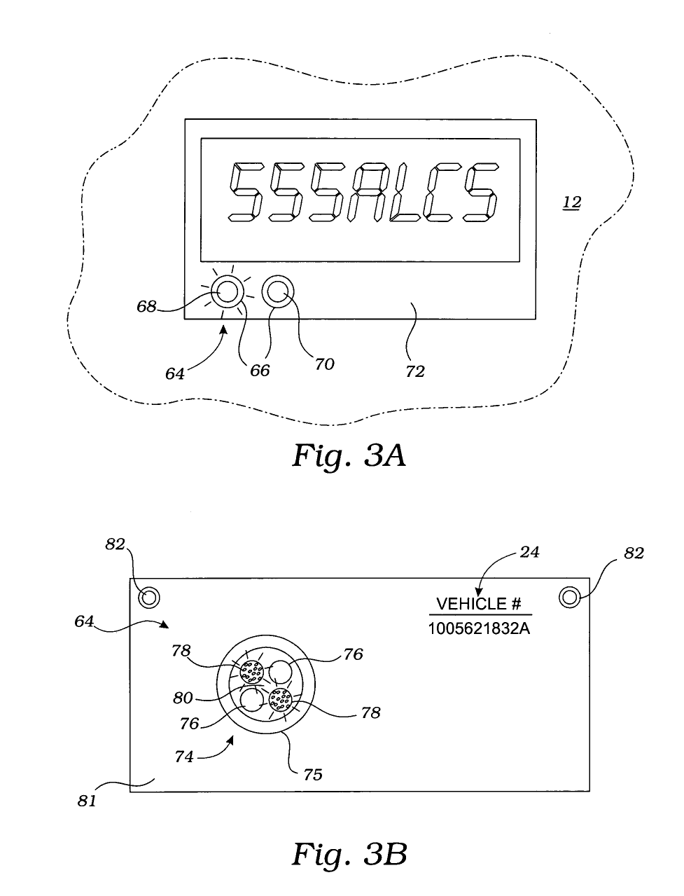

As shown in FIG. 3A, in another embodiment the status indicator 64 includes a pair of LEDs 66, a green LED 68 and a red LED 70, that are mounted on a license plate frame 72 of the vehicle 12. The pair of LEDs 66 function to provide the following signals:

GREEN—When the green LED 68 is illuminated, the vehicle 12 is legally registered and in compliance with all state registration and insurance codes;

RED—When the red LED 70 is illuminated, the vehicle's 12 registration and or insurance coverage has recently expired, or the owner of the vehicle 12 has an infraction on his or her record; and

FLASHING RED—When the red LED 70 is flashing, the vehicle's 12 has been reported as stolen, and/or the owner of the vehicle 12 is being sought by law enforcement. Of course, those skilled in the art can determine many factors that could be tracked and reported by the status indicator 64, potentially including LEDs of other colors. It is important, however, that the status indicator 64 be simple and straightforward to clearly report simple status information.

In another embodiment the status indicator 64 may include an LED bulb 74 with multiple LEDs for brighter illumination and potentially a greater range of reporting capabilities. In one embodiment, as shown in FIG. 3B, the LED bulb 74 includes a housing 75 that includes at pair of red LEDs 76 and a pair of green LEDs 78 mounted around a resistor 80. In this embodiment, the color of the LED bulb 74 is determined by which of the pair of LEDs 76 or 78 is illuminated. While the LED bulb 74 may include a pair of red LEDs 76 and a pair of green LEDs 78 to ensure that the LED bulb 74 is sufficiently bright, it is possible that the LED bulb 74 could include only a single red LED and a single green LED, or several red LEDs and several green LEDs, depending upon the brightness of the LEDs and the requirements of the status indicator 64.

The LED bulb 74 may be mounted upon a carrier card 81 that includes a pair of suction cups 82. The carrier card 81 may be adapted to be mounted in the rear window of the vehicle 12 using the pair of suction cups 82. While the pair of suction cups 82 is used in one embodiment, other means for mounting the carrier card 81 in the rear window, or side window, could also be used, including adhesive tape, hooks and loops (VELCRO®), or any other equivalent mounting means.

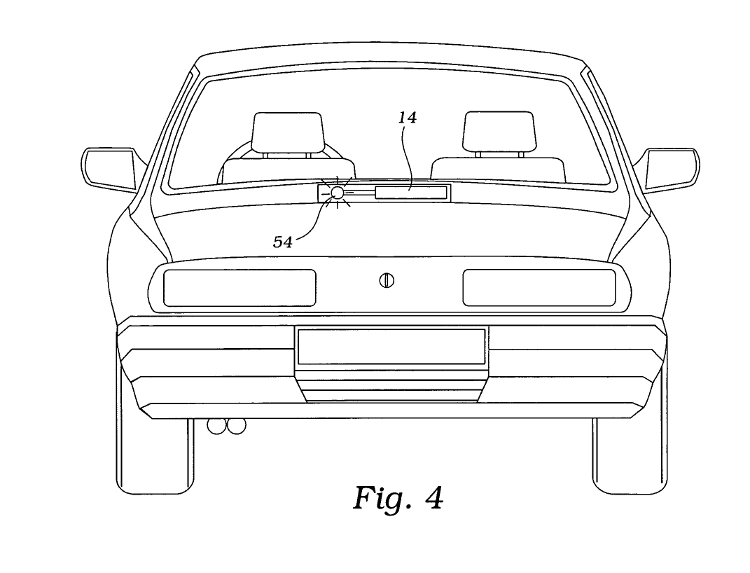

As shown in FIG. 4, the legal compliance indicator 54 may also be built into the vehicle 12. Those skilled in the art might devise many locations which may be suitable for such installation, and the present invention as claimed should include any particular location. In one embodiment, the legal compliance indicator 54 is mounted adjacent the third brake light 14. Alternative locations for the legal compliance indicator 54 include but are not limited to the bumper, the trunk, the brake light, or any other suitable surface, either inside or outside of the vehicle 12.

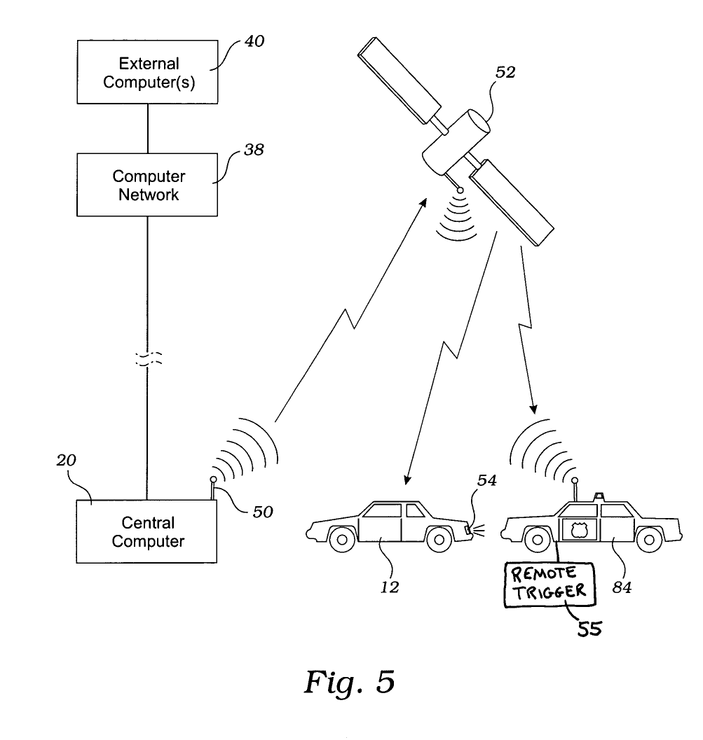

As shown in FIG. 5, a law enforcement vehicle 84 responds to the legal compliance indicator 54 when the officer sees the first and second red/green LEDs 90 and 92 (or other lights described above) illuminated red, or flashing red. The officer is able to access the central computer 20 to download information from the vehicle database 22 to assist in dealing with the noncompliance of the vehicle 12. For example, the dispatcher (now shown) for the officer could access the computer network 38 using techniques well known in the art and tell the police, over the existing communications network the status of the vehicle 12. In alternative embodiments, the police could use an advanced wireless communication device (not shown) to access information directly.

In use, when the vehicle 12 is legally compliant the microprocessor 58 would initially direct the status indicator 64 to show that the vehicle 12 is legally compliant. In the embodiment shown in FIGS. 2A-2D, this is accomplished by illuminating both the first and second red/green LEDs 90 and 92 in the green mode. In the embodiment shown in FIG. 3A, only the green LED 68 is illuminated, and the red LED 70. The status indicator 64 will remain in this mode until there is a change in the status of the central computer 20.

As soon as there is a change in any of the external computers 40, such as the law enforcement computer 42, the insurance company computer 44, or the DMV computer 46, the change is reported to the central computer 20 via the computer network 38 and stored in the vehicle database 22. For example, if the DMV computer 46 were to show that the registration of the vehicle 12 was about to expire, this information would be forwarded to the central computer 20, which would update the vehicle database 22 to change the DMV status 30 from registered to due to expire in 30 days. The central computer 20 would then encode this information with the unique vehicle identifier 24 of the vehicle 12, and transmit this information to the legal compliance indicator 54.

When the legal compliance indicator 54 received the signal with the vehicle transmitter/receiver 56, and decoded the message with the decoder 59, the microprocessor 58 would then recognize the unique vehicle identifier 24 and alter the status indicator 64 from “green” to “red” (for example, turning the first and second red/green LEDs 90 and 92 from green to red). Any passing policeman would be able to immediately recognize that the vehicle 12 is not properly registered and take action, at least to warn the driver to renew the registration. Of course, the data from the external computers 40 would not have to transmitted directly to the central computer 20, but could be transmitted via lower tech channels and then inputted manually into the central computer 20.

The benefit of the status indicator 64 is that the DMV would no longer have to print and mail registration stickers, and the owner of the vehicle 12 would no longer have to affix the registration stickers to their vehicle 12. It would also no longer be possible to steal registration stickers and use them to fool police into thinking the vehicle 12 was registered. The legal compliance indicator 54 would remain fixed on the vehicle 12, potentially for the life of the vehicle 12, displaying the compliance status of the vehicle 12.

If the vehicle 12 were reported stolen, the signal would cause the legal compliance indicator 54 to flash red, as described above, thereby alerting any nearby law enforcement vehicle 84 (or even other motorists) that the vehicle 12 has been stolen, or was involved in a kidnapping, or other serious crime. The affirmative warning of the flashing red legal compliance indicator 54 would enable many stolen vehicles 12 to be recovered without requiring police to search for specific stolen vehicles 12, but only for vehicles 12 with flashing red lights.

Of course, to enable the legal compliance indicator 54 to function, it would be necessary to prevent tampering with the legal compliance indicator 54. Various anti-tampering devices and methods are known in the art, and any of these prior art devices or methods may be adapted to the present invention.

The power supply 62 may be the battery of the vehicle 12 directly wired into the legal compliance indicator 54. In an alternative embodiment, the power supply 62 may be provided by a separate battery (not shown) directly attached to the legal compliance indicator 54. The separate battery would preferably be securely stored within the legal compliance indicator 54 to prevent tampering. In yet another embodiment, the legal compliance indicator 54 further includes a solar cell (not shown) that can power the legal compliance indicator 54 as well as recharge the separate battery.

In an alternative embodiment, the power supply 62 is a power storage circuit (not shown) that derives power from the transmission that is received. When the transmission is received, the circuit stores the energy generated by the signal and uses the energy to temporarily power the microprocessor 58 and the status indicator 64. The advantage of this arrangement is that no components would have to be wired to the vehicle 12, thereby facilitating installation, and no batteries would ever have to be replaced. The disadvantage is that the status indicator 64 would have to be queried in order to be activated, rather than being always on and advertising the status of the vehicle 12. Alternative power arrangements can be devised by those skilled in the art, and such alternatives should be considered within the scope of the invention.

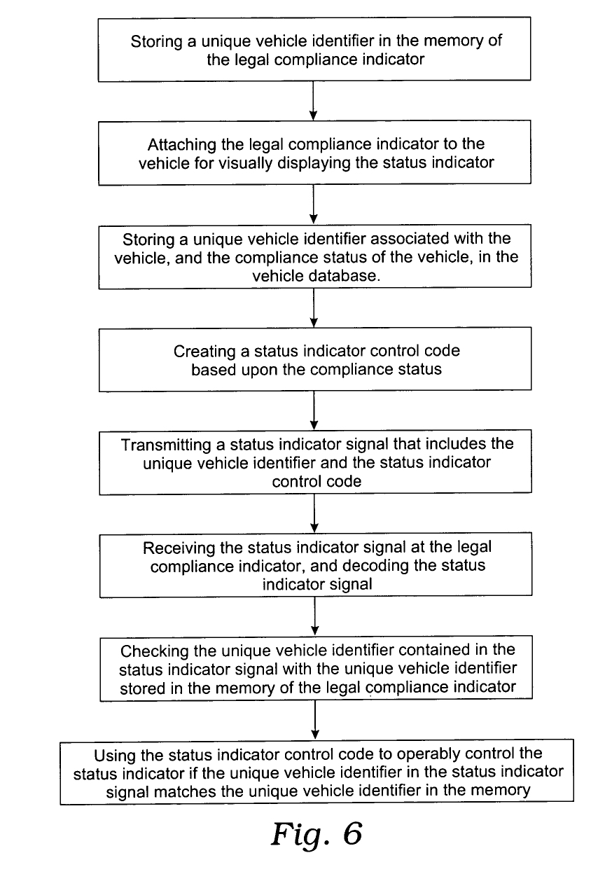

As shown in FIG. 6, the invention includes a method for monitoring the compliance status of the vehicle using the vehicle compliance system described above. The status indicator described above is operably controlled by a status indicator control code generated by the central computer.

The unique vehicle identifier 24 assigned to each vehicle (such as that vehicle's VIN number) is stored in the memory 60 of the legal compliance indicator 54. The legal compliance indicator 54 is then attached to the vehicle 12 for visually displaying the status indicator 64 described above. Some methods of attachment are described above; however, the invention is not limited thereto, and should also encompass alternative or equivalent attachment method or location. The unique vehicle identifier 24 associated with the vehicle 12 is also stored in the vehicle database 22.

The compliance status of the vehicle 12 is also stored in the vehicle database. This can be drawn from the external computers 40, as described above, across the computer network 38, or it can be manually entered.

When there is a change to the vehicle database 22, or on a periodic basis, a status indicator control code is created based upon the compliance status. A status indicator signal is then transmitted that includes the unique vehicle identifier 24 and the status indicator control code. Since the generation and transmission of the status indicator signal is within the skill of one skilled in the art, a more detail discussion of the process is not included herein.

The status indicator signal is received at the legal compliance indicator 54 by the vehicle transmitter/receiver 56, and decoded by the microprocessor 58/decoder 59. The unique vehicle identifier 24 contained in the status indicator signal is then compared with the unique vehicle identifier 24 stored in the memory 60 of the legal compliance indicator 56, and if there is a match, the status indicator control code is used to operably control the status indicator 64.

With reference to the first embodiment, shown in FIGS. 2A-2D, wherein the status indicator 64 includes a first red/green LED 90 and a second red/green LED 92, the status indicator control code operates as follows: when the compliance status of the vehicle is compliant, both the first and second red/green LEDs 90 and 92 are green (as shown in FIG. 2A); when the compliance status of the vehicle is partially-compliant (for example, if the registration is about to expire), the first red/green LED is green 90 and the second red/green LED 92 is red (as shown in FIG. 2B); when the compliance status of the vehicle 12 is non-compliant (for example, if the registration has expired), both the first and second red/green LEDs 90 and 92 are red (as shown in FIG. 2C); and when the compliance status of the vehicle 12 is stolen, both the first and second red/green LEDs 90 and 92 are flashing red (as shown in FIG. 2D). The first and second red/green LEDs 90 and 92 may also flash red when the vehicle 12 has been reported in an accident, used in a kidnapping, or any other serious infractions, legal violations, or safety issues. This system may also be used to track the driver of the vehicle—for instance, if the driver has an outstanding warrant for his/her arrest.

Similarly, when the status indicator includes a green LED 68 and a red LED 70, as shown in FIG. 3A, the status indicator control code operates as follows: when the compliance status of the vehicle 12 is compliant, the green LED 68 is illuminated and the red LED 70 is not illuminated; and when the compliance status of the vehicle 12 is non-compliant, the red LED 70 is illuminated and the green LED 68 is not illuminated. The red LED 70 may also flash, as described above, when the compliance status is stolen (a term including all of the other circumstances described above).

As shown in FIG. 1, the vehicle legal compliance system 10 may also include a GPS 65 (global positioning system) for the purposes of monitoring the location of the vehicle 12. The inclusion of the GPS 65 enables the police to readily locate the vehicle 12 in the event that the vehicle database 22 shows a serious infraction. For example, if the vehicle 12 is reported stolen, or is used in a crime, not only would the status indicator 64 begin to flash red, but the police would also be able to receive directions that would lead them directly to the vehicle 12. It is important that the GPS 65 is not activated until the central computer 20 receives a report that a serious infraction or crime has been committed. It is up to the police or other authorized agency to determine what infractions or crimes are serious enough to warrant the activation of the GPS 65. Otherwise, the GPS 65 could not be activated, thereby protecting the privacy of the driver of the vehicle 12.

While the preferred embodiments of the present invention have been described, those skilled in the art can devise alternative arrangements and structures that are equivalent to the described invention, and these alternative embodiments should be considered within the scope of the present invention.

What is claimed is:

1. A vehicle legal compliance system for reporting a compliance status of a vehicle, the vehicle legal compliance system comprising:
a central computer having a vehicle database, the vehicle database being adapted for storing a unique vehicle identifier associated with the vehicle, and the compliance status of the vehicle;
a central processor for converting the unique vehicle identifier and the compliance status into a status indicator signal;
a central transmitter/receiver operably connected to the central computer for transmitting the status indicator signal; and
a legal compliance indicator having a vehicle transmitter/receiver that is operably attached to a microprocessor, which is operably attached to a status indicator, such that the vehicle transmitter/receiver receives the status indicator signal, and the microprocessor decodes the status indicator signal for operably controlling the status indicator,
the legal compliance indicator being adapted to be operably attached to the vehicle for displaying the status indicator, which is operably controlled by the status indicator signal.

2. The vehicle legal compliance system of claim 1 further comprising:
an external computer operably connected to a computer network;
a means for operably connecting the central computer to the computer network; and
a means for importing data from the external computer to the central computer.

3. The vehicle legal compliance system of claim 2 wherein the external computer is a DMV computer.

4. The vehicle legal compliance system of claim 2 wherein the external computer is an insurance company computer.

5. The vehicle legal compliance system of claim 2 wherein the external computer is a law enforcement computer.

6. The vehicle legal compliance system of claim 1 wherein the microprocessor of the legal compliance indicator is operably attached to a GPS.

7. The vehicle legal compliance system of claim 1 wherein the vehicle database includes a DMV status.

8. The vehicle legal compliance system of claim 1 wherein the vehicle database includes an insurance status.

9. The vehicle legal compliance system of claim 1 wherein the vehicle database includes a theft status.

10. The vehicle legal compliance system of claim 1 wherein the status indicator includes a first red/green LED and a second red/green LED.

11. The vehicle legal compliance system of claim 10 wherein the status indicator operates as follows:
when the compliance status of the vehicle is compliant, both the first and second red/green LEDs are green;
when the compliance status of the vehicle is non-compliant, both the first and second red/green LEDs are red; and
when the compliance status of the vehicle is stolen, both the first and second red/green LEDs are flashing red.

12. The method of claim 1 wherein the status indicator includes a green LED and a red LED.

13. The vehicle legal compliance system of claim 12 wherein the status indicator operates as follows:
when the compliance status of the vehicle is compliant, the green LED is illuminated and the red LED is not illuminated; and
when the compliance status of the vehicle is non-compliant, the red LED is illuminated and the green LED is not illuminated.

14. A method for monitoring a compliance status of a vehicle, the method comprising the steps of:
a) providing a vehicle legal compliance system having
a central computer having a vehicle database and a central transmitter/receiver; and
a legal compliance indicator having a central processor, a memory, and a status indicator, the status indicator being adapted to be operably controlled by a status indicator control code;
b) storing a unique vehicle identifier in the memory of the legal compliance indicator;
c) attaching the legal compliance indicator to the vehicle for visually displaying the status indicator;
d) storing a unique vehicle identifier associated with the vehicle, and the compliance status of the vehicle, in the vehicle database;
e) creating a status indicator control code based upon the compliance status;
f) transmitting a status indicator signal that includes the unique vehicle identifier and the status indicator control code;
g) receiving the status indicator signal at the legal compliance indicator, and decoding the status indicator signal;
h) checking the unique vehicle identifier contained in the status indicator signal with the unique vehicle identifier stored in the memory of the legal compliance indicator; and
i) using the status indicator control code to operably control the status indicator if the unique vehicle identifier in the status indicator signal matches the unique vehicle identifier in the memory.

15. The method of claim 14 wherein the status indicator includes a first red/green LED and a second red/green LED.

16. The method of claim 15 wherein the status indicator control code operates as follows:
when the compliance status of the vehicle is compliant, both the first and second red/green LEDs are green;
when the compliance status of the vehicle is non-compliant, both the first and second red/green LEDs are red; and
when the compliance status of the vehicle is stolen, both the first and second red/green LEDs are flashing red.

17. The method of claim 14 wherein the status indicator includes a green LED and a red LED.

18. The method of claim 17 wherein the status indicator control code operates as follows:
when the compliance status of the vehicle is compliant, the green LED is illuminated and the red LED is not illuminated; and
when the compliance status of the vehicle is non-compliant, the red LED is illuminated and the green LED is not illuminated.

19. A method for monitoring a compliance status of a vehicle, the method comprising the steps of:
a) providing a vehicle legal compliance system having
a central computer having a vehicle database and a central transmitter/receiver; and
a legal compliance indicator having a central processor, a memory with a unique vehicle identifier, and a status indicator, the status indicator being adapted to be operably controlled by a status indicator control code;
b) attaching the legal compliance indicator to the vehicle for visually displaying the status indicator;
c) storing a unique vehicle identifier associated with the vehicle, and the compliance status of the vehicle, in the vehicle database;
d) creating a status indicator control code based upon the compliance status;
e) transmitting a status indicator signal that includes the unique vehicle identifier and the status indicator control code;
f) receiving the status indicator signal at the legal compliance indicator, and decoding the status indicator signal;
g) checking the unique vehicle identifier contained in the status indicator signal with the unique vehicle identifier stored in the memory of the legal compliance indicator;
h) using the status indicator control code to operably control the status indicator if the unique vehicle identifier in the status indicator signal matches the unique vehicle identifier in the memory; and
i) interrogating the legal compliance indicator with a remote trigger, thereby causing the legal compliance indicator to visually display the compliance status.

20. The method of claim 19 wherein the remote trigger is a radar gun.
